(19) United States
(12) Patent Application Publication
(10) Pub. No.: US 2010/0183282 A1
(43) Pub. Date: Jul. 22, 2010

(54) METHOD AND DEVICE FOR CONTROLLING ACCESS TO CONTENT

(75) Inventors: Gopalakrishnan Nair Gopakumar, Eindhoven (NL); Ajeesh Gopalakrishnan, Nijmegen (NL); Hendrik Frank Moll, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/162,362

(22) PCT Filed: Jan. 31, 2007
(86) PCT No.: PCT/IB06/50314

§ 371 Date: Jul. 28, 2008

(30) Foreign Application Priority Data
Jan. 31, 2006 (EP) 06101080.7

(51) Int. Cl. H04N 7/00

(52) U.S. Cl. 386/95; 386/E05.001

(57) ABSTRACT

The present invention relates to a method of controlling access to content comprising the steps of receiving content having a first content rating associated therewith for controlling access to the content, receiving a request to associate a second content rating with an attribute of the content for controlling access to the content, saving the second content rating in such a way that the second content rating is associated with the attribute of the content for controlling access to the content. This is useful in all disc players such as HD-DVD, Blu-ray disc players that enable playback of content.

The invention relates to a method of controlling access to content.

The invention also relates to a device for controlling access to content.

The invention also relates to a software program for controlling access to content.

The exposure of children to inappropriate material, such as sexual content, violence, and coarse language has become a great concern. Recent technological developments allow access control of content to which children are exposed. The basic idea is to prevent children from watching adult content without parental consent, while allowing adults to watch child-safe content. For example, DVD players include a parental control feature. The purpose of this parental control feature is to disable the playing of DVD discs that are deemed unsuitable for children. To this end, some discs are encoded with a specific parental control level. If the parental control level of the DVD disc is higher than the parental control level of the DVD player, the player will not play the DVD disc. This parental control feature allows parents to limit the type of DVD content that can be played on the player. An embodiment of a method of controlling access to content is disclosed in US20050028191, wherein the method comprises:

receiving content having a first content rating associated therewith for controlling access to the content,

storing the content and the associated first content rating,

receiving a request to change the first content rating to a second content rating, and

storing the second content rating so that the second content rating is associated with the content for controlling access to the content.

The solution described in US20050028191 has a problem. The second content rating is associated with the content and the content in its entirety is physically stored on a storage medium e.g., a hard disc. For subsequent accesses of the same content from a different source e.g., same content from another DVD disc or from another Blu-ray disc or from another remote server, the whole content physically has to be saved again and the second content rating re-assigned. This is time-consuming since the entire content has to be saved on the storage medium e.g., a hard disc. Even though the content is already saved and the associated second rating available, to control access to the same content available from a different source, the entire content has to be physically saved again and the second content rating re-assigned. The process of re-assigning the second content rating requires navigation of the player menu, which is repetitive, time-consuming, tedious and may quickly become annoying. The solution disclosed in US20050028191 does not give flexibility to assign only once the second content rating and remove the obligation of re-assigning the second content rating on subsequent access of the same content from a different source without the entire content being saved again e.g., on a hard disc.

Therefore, it is an object of the invention to provide a method of the kind described in the opening paragraph that gives flexibility to assign only once the second content rating and use the second content rating for subsequent access of the same content from a different source without saving the entire content.

It is a second object of the invention to provide a device of the kind described in the opening paragraph that gives flexibility to assign only once the second content rating and use the second content rating for subsequent access of the same content from a different source without saving the entire content.

It is a third object of the invention to provide a software program of the kind described in the opening paragraph that gives flexibility to assign only once the second content rating and use the second content rating for subsequent access of the same content from a different source without saving the entire content.

The first object of the invention is achieved by providing a method of controlling access to content comprising:

receiving content having a first content rating associated therewith for controlling access to the content,

receiving a request to associate a second content rating with an attribute of the content for controlling access to the content,

saving the second content rating in such a way that the second content rating is associated with the attribute of the content for controlling access to the content.

The first object of the invention is achieved by associating the second content rating with various attributes of the content for controlling access to the content. This feature of associating the second content rating with the attributes of the content gives flexibility to save the attribute of interest and associate it with a second content rating. The attribute of the content is saved and associated with the second content rating, and not the content in its entirety. This provides flexibility to use the saved second content rating for controlling access to the content during later access of the same content from a different source or from the same source. On future access of the same content, the saved second content rating is checked with the corresponding attribute of the content for controlling access to the content. Hence, for subsequent accesses of the same content from a different source, the second content rating can still be used for controlling access to the content without re-assigning the second content rating or saving the entire content again.

In an embodiment of the method according to the invention, the attribute of the content comprises a title of the content and the second content rating is associated with the title of the content for controlling access to the content. This embodiment allows associating the second content rating with a particular title of interest. The second content rating is used for controlling access to the content during future reloads of the same content. If the content comprising movie titles is available on a DVD disc or a blu-ray disc, then the second content rating can be associated with a particular title of interest. E.g., if the second content rating is associated with the title “Titanic”, then only the title “Titanic” is saved and not the entire movie “Titanic”. Irrespective of the source of the content, whether the content comprising the movie title “Titanic” is from the same DVD disc/blu-ray disc or from a different DVD disc/blu-ray disc or from a remote server, the second content rating will still be used for controlling access to the content comprising the movie title “Titanic”.

In a still further embodiment of the method according to the invention, the method can retain the second content rating for a single title during multiple playbacks of the single title. This embodiment allows the second content rating to be used for all subsequent playbacks of the single title even in the case of an unload and later reload of the single title. E.g., a user gets a blu-ray disc from his friend that comprises the movie title “Titanic”. Then he assigns a second content rating to the movie title “Titanic” and plays the movie “Titanic”. When the user wants to view the same movie title “Titanic” again, he borrows an-other blu-ray disc comprising movie title “Titanic” from another friend. In such a scenario, the saved second content rating for the movie title “Titanic” is used for controlling access to the movie title “Titanic”.

In a still further embodiment of the method according to the invention, the method allows to retain the second content rating for a single load of the title. In this scenario, the second content rating is valid only for one-time playback of the movie title “Titanic”. After the movie “Titanic” is played, the second content rating is erased. For subsequent playback of the title “Titanic”, the second content rating has to be re-assigned. This is useful in scenarios where the adult user wants to view adult content and does not like to save the second content rating, since someone may gain unauthorized access to view adult content.

In a still further embodiment of the method according to the invention, the attribute of the content comprises an author of the content and the second content rating is associated with the author of the content for controlling access to the content. This embodiment allows associating the second content rating with a particular author of interest. The second content rating controls access to all the content from the author. E.g., a user gets a Blu-ray disc from his friend authored by 20^{th} Century Fox that comprises the movie title “Titanic”. The user assigns a second content rating associated with the author of the content e.g., 20^{th} Century Fox. When the user accesses any content that is authored by 20^{th} Century Fox, from a different source e.g., an-other DVD disc or Blu-ray disc or from a remote server, the assigned second content rating is used to control access to the content. Setting the second content rating once ensures that for all subsequent accesses of content from the author, the second content rating is used. This embodiment allows the second content rating to be used for controlling access to all the content from the author e.g., 20^{th} Century Fox, during multiple playbacks of the content.

In a still further embodiment of the method according to the invention, the method provides an option to reset to the first content rating or to the second content rating for controlling access to the content. This allows the adult viewers to reset to the first content rating when the content is to be viewed by children and to reset to the second content rating when it is to be viewed by adults. The first content rating associated with the content is unaltered.

In a still further embodiment of the method, the second content rating is deleted based on at least one of the following criteria:

expiration of a pre-determined time period that is configurable by the user,

deletion of an oldest entry.

The user can define a pre-determined time period and the second content rating is automatically erased after the pre-determined time period. This is advantageous in certain scenarios e.g., where children have gone out for a week during vacation and during that week adults use second content rating for controlling access to content. In case, the adult viewer forgets to reset the second content rating after a week, the second content rating is reset automatically after the pre-determined time period of one week. The adult viewer need not worry about tracking the second content rating since it is reset automatically once the children are back from vacation. In a further embodiment, the method allows deletion of an oldest entry to give way for a new entry.

The content to be received is stored on a storage medium, in particular a Blu-ray disc or a HD-DVD disc, or located on a remote server. The content can be interactive content.

The second object of the invention is achieved by providing a device, in particular a Blu-ray disc player or a HD-DVD disc player, the device comprising:

receiving means arranged to receive content having a first content rating associated therewith for controlling access to the content,

requesting means arranged to receive a request to associate a second content rating with an attribute of the content for controlling access to the content,

saving means arranged to save the second content rating in such a way that the second content rating is associated with the attribute of the content for controlling access to the content.

In an embodiment of the device according to the invention, the device comprises a register to save the second content rating. The register is mapped to the device memory, e.g., a Blu-ray disc player memory. This is advantageous since it helps in storing and recalling the second content rating from the device memory depending on a user selected scenario.

In a further embodiment of the device according to the invention, the register comprises at least one of: a title register, an author register, a general register, a download content register, a download author register or a download general register. The title register ensures that the second content rating for a title is retained during the span of multiple reloads of the title. The author register ensures that the second content rating value is used for all subsequent runs of all the titles from the author even in case of subsequent unloads and reloads of the titles. The general register ensures that the second rating value is valid only for a current title. Once the title is played, the second content rating is erased. The download content register ensures that the second content rating is used during the span of multiple downloads of the downloaded content from the Internet. The download author register ensures that the second content rating value is used for all subsequent runs of all the downloaded content from the author even in case of subsequent unloads and reloads of the downloaded content. The download general register ensures that the second rating value is valid only for a current downloaded content. Once the downloaded content is played, the second content rating is erased.

The third object of the invention is achieved by providing a software program comprising executable codes for performing the method of controlling access to the content as described in the previous paragraphs.

These and other objects of the invention will be further elucidated and described, by way of example only, with reference to the accompanying drawings in which:

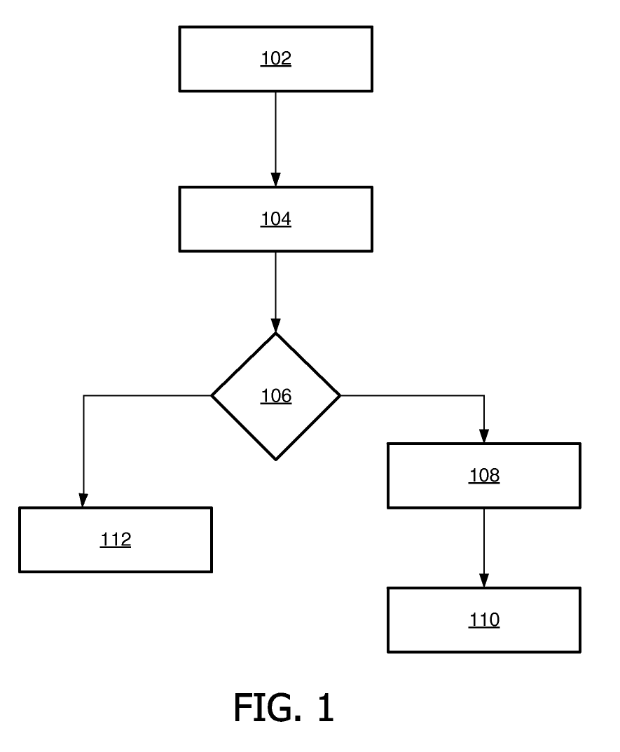

FIG. 1 shows a flow chart of a method of controlling access to content in accordance with an exemplary embodiment of the invention,

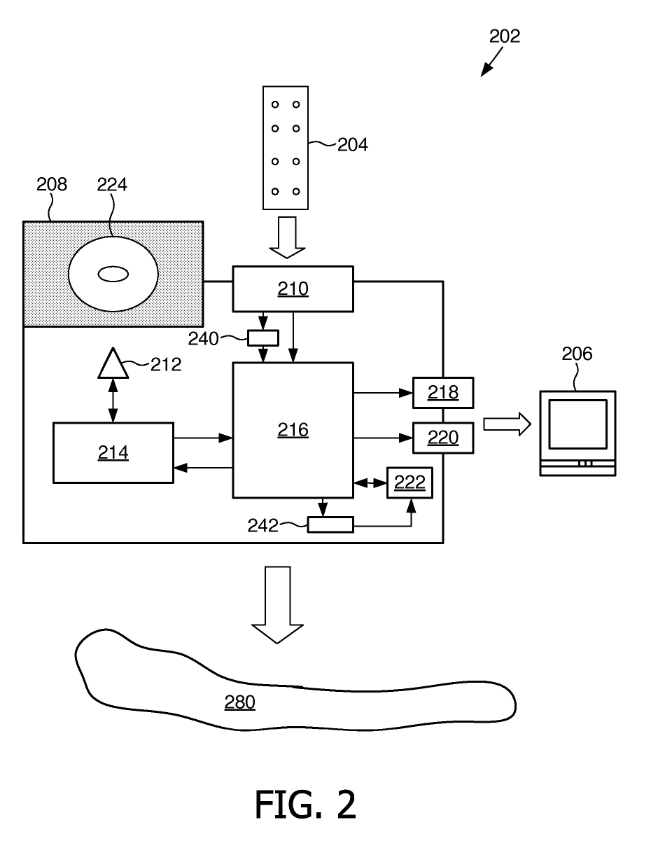

FIG. 2 is a block diagram that depicts one example of a player device, in particular a Blu-ray disc player, to which the present invention is applied.

In step 102 as shown in FIG. 1, content having a first content rating associated therewith for controlling access to content is received. This content is received from a recording medium such as a Blu-ray disc or a HD-DVD disc or is received by downloading the content from a remote server. The first content rating associated with the received content is based on the Motion Picture Association of America (MPAA) rating system that is disclosed in WO2004/059942, which is herewith incorporated by reference. In this rating system, 8 is the most restrictive level (adults only) and 1 is the least restrictive level (all ages). The content received can be TV content, audio content, video content, movies, computer games, web sites, site within a network or compilation of songs. For illustrative purposes, the MPAA rating has been considered, but the present invention is not limited to any particular rating system. Other rating schemes e.g., DVD ratings, Electronic program guide ratings e.g., Tel star, Echo star can also be used. In step 104 a user request is received to associate a second content rating with an attribute of the content for controlling access to the content. The attribute of the content comprises at least one of: a title of the content or an author of the content. In step 106 a check is carried out to determine the user authorization. There may be means arranged a) to determine whether the user is allowed to associate a second content rating with an attribute of the content; this can be achieved e.g., by a parental control resident application in the Blu-ray player or HD-DVD player, and b) to authenticate the rights of the user by prompting the user to enter a password or access code, e.g., a 4 digit code, that a viewer can enter through the keypad of the remote control. Tampering to gain unauthorized access to the content may be overcome by including certain features to prevent unauthorized access, e.g., if an incorrect password is entered a number of times, the method may be instructed to disable access to the content. For an authorized user, in step 108 the second content rating is associated with the user specified attribute of the content. Next, in step 110, the second content rating is saved in such a way that the second content rating is associated with the user-specified attribute of the content for controlling access to the content. If the user authorization is not successful (i.e., in step 106), then in step 112 the content with first content rating is made available to the user. Associating the second content rating with an attribute of the content gives flexibility to save the attribute of users' interest and associate it with a second content rating. The second content rating is used for controlling access to content during later access of the same content from a different source or from the same source. On future access of the same content, the saved second content rating is checked with the corresponding attribute of the content for controlling access to the content. For subsequent access of the same content from the same source or from a different source, the second content rating is used for controlling access to the content without re-assigning the second content rating or saving the entire content again.

In an embodiment of the method according to the invention, the attribute of the content comprises a title of the content and the second content rating is associated with the title of the content for controlling access to the content. This embodiment allows associating the second content rating with a particular title of interest. This is illustrated by means of an example. The received content comprises the movie “Titanic” associated with a first content rating for controlling access to the content. A user request is received to associate a second content rating with the title of the movie “Titanic”. A second content rating is associated with the title of the content, namely the title “Titanic”, and saved. The whole content comprising the movie Titanic can be accessed with the second content rating associated with the title “Titanic”. Associating the second content rating with the title of the content gives flexibility to save the title instead of the whole content comprising the movie Titanic. This second content rating is memorized with respect to the corresponding title Titanic. Irrespective of the source of the content, on future reloads of the content comprising movie title “Titanic”, the second content rating is used for controlling access to the content comprising the movie Titanic. System description Blu-ray Disc read only format part 3 audiovisual specifications identifies a player status register PSR 13 for parental control. But for providing the flexibility of associating a rating with various attributes of the content more registers are required. Hence, the present invention proposes a set of register namespaces according to iHD-DVD specification that maps to player registers. A new register named title register is used to memorize the second content rating values per title. This title register is initialised from the player memory on title start up. The value is saved to the player memory when the title unloads. The value is limited to the current title. Based on this scenario, X different registers can be added, where X is an integer in the range of e.g., 0 to 10.

In a still further embodiment of the method according to the present invention, the second content rating is used for controlling access to a single title during multiple playback of the single title. As explained in the previous paragraph, the content comprising the movie “Titanic” associated with a first content rating is received. A user associates a second content rating with the title of the content, namely “Titanic”. The second content rating is saved in a title register. After playing back the content, i.e., the movie “Titanic”, the second content rating is still retained in the title register. On future access of the content comprising the movie Titanic by the player, the title register is checked. If any mapping to the “title Titanic” exists, the last-saved second content rating in the title register is used for controlling access to the content. For subsequent access of the content comprising the movie Titanic from any source, e.g., a recording medium such as a Blu-ray disc or HD-DVD disc or from a remote server, the second content rating already saved is used to control playback of the movie “Titanic”. By checking for the corresponding title, the second rating controls access to the content. In essence, this embodiment allows the second content rating to be used for all subsequent playbacks of the single title in the case of a current unload and later reload of that single title by saving the second content rating in a title register and restoring this value from the player memory.

In a still further embodiment of the method according to the invention, the second content rating is used for controlling access to a single title only for one-time playback of the single title. In this scenario, the saved second content rating is valid only for one-time playback of the title. As explained in the previous paragraphs, the user associates a second content rating with the “title Titanic”. The second content rating is saved in a general register. The general register is initialised from title mark up. The value is available only during a current run of the title. Based on this scenario, X different registers can be added, where X is an integer in the range of e.g., 0 to 10. After playing back the content comprising the movie title “Titanic”, the general register gets flushed or erased. For subsequent access of the movie title “Titanic”, the first content rating associated with the content is used for controlling access to the content. The second content rating stored in the general register is available only for one-time playback of the movie title “Titanic”. This is advantageous in situations where the adult viewer wants to view adult content and does not like to save the second content rating, since someone may gain unauthorized access to view adult content.

In a still further embodiment of the method according to the invention, the attribute of the content comprises an author of the content and the second content rating is associated with the author of the content for controlling access to the content. This is illustrated by means of the example considered in the previous paragraphs. The received content comprises the movie “Titanic” associated with a first content rating for controlling access to the content. The user associates a second content rating with the author of the content comprising the movie “Titanic”, e.g., 20^{th} Century Fox. The whole content comprising the movie Titanic can be accessed with the second content rating associated with the author e.g., 20th Century Fox. When the user accesses any content that is authored by 20^{th} Century Fox, from a different source e.g., from a Blu-ray disc or from a HD-DVD disc or from a remote server, the second content rating is used to control access to the content. Associating second content rating with the author of the content gives flexibility to save the author of the content instead of the whole content. A new register named author register is used to memorize the second content rating per author. This author register is initialised from the player memory on title start up. The value is saved to the player memory when the title unloads. Values are available to all the titles from that particular author. Based on this scenario, X different registers can be added in the author register, where X is an integer in the range of e.g., 0 to 10. The second content rating is memorized with respect to the corresponding author e.g., 20^{th} Century Fox. Irrespective of the source of the content, on future reloads of all the content from that author e.g., 20^{th} Century Fox, the second content rating is used for controlling access to the content.

In a still further embodiment of the method according to the present invention, the second content rating is used for controlling access to all the content from the author, e.g., 20^{th} Century Fox, during multiple playbacks of the content even in case of future unloads and reloads of the content. As explained in the previous paragraphs, the content comprising the movie “Titanic” associated with a first content rating is received. The user associates a second content rating with the author of the content, i.e., 20^{th} Century Fox. The second content rating is saved in an author register. After playing back the content, i.e., the movie “Titanic”, the second content rating is still retained in the author register. On future access of the content comprising the movie Titanic, the author register is checked. If any mapping to the author, e.g., 20^{th} Century Fox, exists, the last-saved second content rating is used for controlling access to the content. For subsequent access of the content comprising the movie “Titanic” from any source authored by 20^{th} Century Fox, e.g., Blu-ray disc or HD-DVD disc or downloaded from a remote server, the second content rating already saved is used to control playback of the movie Titanic. By checking for the corresponding author of the content, e.g., 20^{th} Century Fox, the second content rating controls access to content. In essence, this embodiment allows the second content rating to be used for all subsequent playbacks of the content from the author in the case of a current unload and future reloads of the content by saving the second content rating in an author register and recalling the stored value from the player memory.

In the embodiments described in the previous paragraphs, the content is received from a recording medium, e.g., a HD-DVD disc or Blu-ray disc, or the content is downloaded from a remote server. In the scenario, where the content is downloaded from a remote server, it is possible to associate a second content rating with an attribute of the downloaded content and save the second content rating in such a way that the second content rating is associated with the attribute of the downloaded content for controlling access to the downloaded content. Based on the user scenario, it is possible to save the second content rating and recall the second content rating. The user scenarios are illustrated below:

Scenario 1: The user associates a second content rating with a single downloaded content. The second content rating is saved in the download content register. This ensures that the second content rating value is memorized for the single downloaded content and the second content rating is used for controlling access to the single downloaded content for all subsequent downloads of the single downloaded content. The download content register is initialised from the memory of the player upon playback of the downloaded content. The value is saved to the player memory when the downloaded content playback is stopped. Based on this scenario, X different registers can be added, where X is an integer in the range of e.g., 0 to 10.

Scenario 2: The user associates a second content rating with the author of the downloaded content. The second content rating is saved in the download author register. This ensures that the second content rating value is memorized for the author of the downloaded content. The second content rating is used for all subsequent runs of all the downloaded content from the author in case of future downloads of the content. The download author register is initialised from the player memory upon playback of the downloaded content. The value is saved to the player memory when the downloaded content playback is stopped. The values are available to all the downloaded content from the same author. Based on this scenario, X different registers can be added, where X is an integer in the range of e.g., 0 to 10.

Scenario 3: The user associates a second content rating for controlling access to a single downloaded content only for one-time playback of the single downloaded content. In this scenario, the second content rating is saved in the download general register. The second content rating stored in the download general register is available only for current playback of the downloaded content. After the downloaded content is played back, the download general register is flushed or erased. In this scenario, the values are available only during the current playback of the downloaded content. Based on this scenario, X different registers can be added, where X is an integer in the range of e.g., 0 to 10.

In essence, there are two different scenarios: a) downloaded content scenario b) titles from a disc scenario. The scenario of downloaded content refers to connected devices having Internet connectivity, where upgrades, new titles can be frequently purchased, and does not need the content to be present in the Blu-ray player/HD-DVD player. The scenario of titles from a disc refers to devices such as Blu-ray players/HD-DVD players without having Internet connectivity, wherein the titles have to be present on a disc, e.g., Blu-ray disc or HD-DVD disc, that is to be loaded onto the player device.

In a still further embodiment of the method according to the invention, the method provides an option to reset to the first content rating or to the second content rating for controlling access to the content. This allows the adult viewers to reset to the first content rating when the content is to be viewed by children and to reset to the second content rating when it is to be viewed by adults. The first content rating associated with the content is unaltered.

In a further embodiment of the method, the second content rating can be deleted based on at least one of the following criteria:

expiration of a pre-determined time period that is configurable by the user,

deletion of an oldest entry

The user can define a pre-determined time period and the second content rating is automatically erased after the pre-determined time period. This is advantageous in certain scenarios e.g., where children are away from home for a week during vacation and during that week adults use second content rating for controlling access to content. In case, the adult viewer forgets to reset the second content rating after a week, the second content rating is reset automatically after the pre-determined time period of one week. The adult viewer need not worry about tracking the second content rating since it is reset automatically once the children are back from vacation. In a further embodiment, the method allows deletion of an oldest entry to give way for a new entry.

The method of controlling access to content described in the embodiments can be implemented in a device, in particular, a Blu-ray disc player device or a HD-DVD disc player device. FIG. 2 is a block diagram that depicts one example of a player device, in particular a Blu-ray disc player, to which the present invention is applied. In FIG. 2, reference numeral 202 denotes a Blu-ray disc player, 204 denotes a remote controller, 206 denotes a TV monitor. The Blu-ray disc player 202 is composed of a tray section 208, a remote controller light receiving section 210, a pick-up 212, a disc read control section 214, a microcomputer 216, a video external output terminal 218, a voice external output terminal 220 and a player memory 222. Reference numeral 224 denotes a Blu-ray disc inserted into the tray section 208. Referring to FIG. 2, while the Blu-ray disc 224 is rotated by a spindle motor (not shown), the recorded content associated with a first content rating is received and read out by the pick-up 212. The pick-up is moved in a radial direction of the Blu-ray disc by a tracking motor (not shown). The tracking motor and spindle motor are rotation-controlled by a servo control system. An RF signal, which is the recorded content read out by the pick-up 212 on the basis of the strength of the light reflected from the Blu-ray disc, after it has been converted into digital data by an RF amplifier (not shown), is supplied to a digital signal processing unit (not shown) of the microcomputer 216. The digital signal-processing unit subjects the received digital data to processing and the processed signal accordingly is output to a TV monitor. For illustration, a TV monitor has been used. It should be noted that any suitable form of display could be used. Further, the Blu-ray disc player 202 includes a parental control feature to disable playing of Blu-ray discs based on the content rating. If the content rating of the Blu-ray disc is higher than the parental control level of the blu-ray disc player 202, the player will not play the Blu-ray disc. This is also the case with downloaded content. The construction shown in FIG. 2 only illustrates portions related to the working principle of a Blu-ray disc player and the means for receiving content having a first content rating and controlling access to the content. The description and detailed explanation of servo circuits to servo control the pick-up 212, the spindle motor, the slider motor, the digital processing unit and the like are omitted since they are constructed in a similar manner as in conventional arts. Further, the Blu-ray disc player 202 can have Internet connectivity via the Internet 280. The content associated with a first content rating available on a remote server can be accessed by the Blu-ray disc player 202 via the Internet 280, processed and displayed on the TV monitor 206. In such a scenario, the downloaded content is processed by the digital signal-processing unit and the processed signal is output to a TV monitor 206. The Blu-ray player 202 further comprises means 240 arranged to receive a request to associate a second content rating with an attribute of the content for controlling access to the content. E.g., this can be implemented as a user interface integrated with the remote control functionality. This can be allowed only for authorized users and there may be means arranged to authenticate the rights of the user by prompting the user to enter a password or access code. The Blu-ray player 202 further comprises means 242 arranged to save the second content rating in such a way that the second content rating is associated with the attribute of the content for controlling access to the content. The means 242 uses a set of register namespaces according to iHD-DVD specification. To this end, the Blu-ray player 202 comprises means arranged to display the attributes of the content and navigation means to select and save the second content rating. In an embodiment of the Blu-ray player 202, the second content rating is mapped to register 242. Based on this scenario, the second content rating is mapped to the register 242 and saved in the player memory 222. Mapping can be done to one of: a title register, an author register, a general register, a download content register, a download author register or a download general register. The details of each of these registers, their characteristics and behaviour of mapping to the player memory 222 are given in table 1 below. The detailed working mode of these registers is illustrated in the previous paragraphs in which a description is given of the embodiments of the method, and hence is omitted here.

TABLE 1
Register namespaces

| Register Namespace | Behaviour/Characteristics |
|---|---|
| Title Register | Initialised from player memory on |
| | title start up. |
| | Value saved to player memory when |
| | title unloads. |
| | Values limited to current title. |
| | Authors may add up to X different |
| | registers in this name-space. |
| Author Register | Initialised from player memory on |
| | title start up. |
| | Value saved to player memory when |
| | title unloads. |
| | Values available to all titles from |
| | current author. |
| | Authors may add up to X different |
| | registers in this name-space. |
| General Register | Initialised from title markup. |
| | Value not saved. |
| | Value available during current run |
| | of title. Authors may add an |
| | unlimited (subject to system |
| | memory constraints) number of |
| | different registers to this name- |
| | space. |
| Download content Register | Initialised from the player memory |
| | on downloaded content playback |
| | Value saved to player memory when |
| | the downloaded content playback is |
| | stopped |
| | Downloaded content may add X |
| | different registers to this name- |
| | space. |
| Download author Register | Initialised from the player memory |
| | on downloaded content playback |
| | Value saved to player memory when |
| | the downloaded content playback is |
| | stopped |
| | Values available to all the |
| | Downloaded content from the same |
| | author/studio |
| | Downloaded content may add X |
| | different registers to this name- |
| | space |
| Download General Register | Values available only during the |
| | current playback of the downloaded |
| | content |
| | Downloaded content may add X |
| | different registers to this name- |
| | space |

The method of controlling access to content according to the present invention may take place in a player device such as a Blu-ray disc player or HD-DVD disc player as illustrated, or in any portable device comprising a player device, e.g., a PDA, a mobile phone.

In embodiments of the invention, the disclosed method of controlling access to content may be implemented as a software program comprising an executable code to be executed by a content processing device such as Blu-ray disc player or HD-DVD disc player. The software program, when executed, causes the content processing device to perform the steps of the methods described in the embodiments for controlling access to the content.

In embodiments of the invention, the content having a first content rating is received and a second content rating associated with the attribute of the content is saved. It is also possible to configure a second content rating in case the received content does not have any rating associated with it, i.e., unrated content. In this scenario, the accessed content does not have any rating and a content rating is configured by the adult viewer and saved. The saved content rating is used for controlling access to the content.

The embodiments of the invention are described with reference to adult control. It should be noted that adult in the present context is intended to encompass any other person, in addition to adults, who desires to prevent access of persons, and in particular children, to inappropriate content. Such persons for example may include administrators of networks or computers available to the public, such as in public libraries, church environments or retail environments, and so forth, or persons who display content at locations where children may be present e.g., in-flight movies displayed in an aircraft. Further, the second content rating here refers to an overridden rating value. Additionally, overriding a rating implies second rating or more by different classes of users. e.g., mother can override sister not vice-versa.

A person skilled in the art can implement the described embodiments of the method for controlling access to content in software or in both hardware and software. It will however be evident that various modifications and changes may be made without departing from the broader scope of the invention, as set forth in the appended claims. The word “comprising” does not exclude the presence of elements other than those listed in a claim or in the description. The word “a” or “an” preceding an element does not exclude the presence of a plurality of such elements. The figures and description are to be regarded as being for illustrative purposes only and may not be used for restricting the invention.

The invention is summarized by providing a method of controlling access to content comprising:

receiving content having a first content rating associated therewith for controlling access to the content,

receiving a request to associate a second content rating with an attribute of the content for controlling access to the content,

saving the second content rating in such a way that the second content rating is associated with the attribute of the content for controlling access to the content.

This is useful in all disc players, such as HD-DVD disc players, blu-ray disc players, that enable playback of content.

1. A method of controlling access to content comprising:
receiving content having a first content rating associated therewith for controlling access to the content,
receiving a request to associate a second content rating with an attribute of the content for controlling access to the content,
saving the second content rating in such a way that the second content rating is associated with the attribute of the content for controlling access to the content.

2. The method as claimed in claim 1, wherein the attribute of the content comprises a title of the content.

3. The method as claimed in claim 2, wherein the second content rating is used for controlling access to a single title during multiple playback of the single title.

4. The method as claimed in claim 2, wherein the second content rating is used for controlling access to a single title only for one-time playback of the single title.

5. The method as claimed in claim 1, wherein the attribute of the content comprises an author of the content.

6. The method as claimed in claim 5, wherein the second content rating is used for controlling access to all the content from the author during multiple playbacks of the content.

7. The method as claimed in claim 1, wherein the method comprises an option to
reset to
the second content rating, or
the first content rating
for controlling access to the content.

8. The method as claimed in claim 1, wherein the saved second content rating is
deleted, based on at least one of the following criteria:
expiration of a pre-determined time period that is configurable by the user,
deletion of an oldest entry.

9. The method as claimed in claim 1, wherein the content is stored on storage
medium, in particular, a Blu-ray disc, or located on a remote server.

10. A device for controlling access to content, the device comprising:
receiving means arranged to receive content having a first content rating associated therewith for controlling access to the content,
requesting means arranged to receive a request to associate a second content rating with an attribute of the content for controlling access to the content,
saving means arranged to save the second content rating in such a way that the second content rating is associated with the attribute of the content for controlling access to the content.

11. The device as claimed in claim 10, wherein the device is a Blu-ray disc player.

12. The device as claimed in claim 10, wherein the device is a HD-DVD disc player.

13. The device as claimed in claim 10, the device further comprising a register to save the second content rating.

14. The device as claimed in claim 13, wherein the register is at least one of: a title register,
an author register, a general register, a download content register, a download author register or a download general register.

15. A software program comprising executable codes for performing the method of claim 1.
